(19) United States
(12) Patent Application Publication
(10) Pub. No.: US 2023/0175183 A1
(43) Pub. Date: Jun. 8, 2023

(54) A CARPET, A CARPET PILE YARN, AND A METHOD FOR PRODUCING THE SAME

(71) Applicant: IKEA SUPPLY AG, Pratteln (SE)

(72) Inventors: Anders BERGNER, Halmstad (SE); Mukesh SHARMA, Älmhult (SE); Arnold E. WILKIE, Merritt Island, FL (US); Jeffrey Scott HAGGARD, Cocoa, FL (US)

(21) Appl. No.: 18/014,006

(22) PCT Filed: Jul. 1, 2021
(86) PCT No.: PCT/SE2021/050661

§ 371 Date: Dec. 30, 2022

(30) Foreign Application Priority Data
Jul. 2, 2020 (SE) 2050822-2

(51) Int. Cl. D05C 17/02; D02G 3/04; D02G 3/44; D01D 5/253; D02G 1/18; D02J 1/08; A47G 27/02; D01D 5/32; D02G 1/16

(52) U.S. Cl. CPC D05C 17/026; D02G 3/045; D02G 3/445; D01D 5/253; D02G 1/18; D02J 1/08; A47G 27/0243; D01D 5/32; D02G 1/165; D10B 2331/04; D10B 2503/04

(57) ABSTRACT

A carpet comprising a backing and pile comprising looped or cut tufts of pile yarn attached to and extending from the backing. The pile yarn comprises un-twisted, entangled filaments. The filaments are self-crimped and optionally textured multi-component filaments. A first component of the multi-component filament comprises a first thermoplastic polymer and a second component of the multi-component filaments comprises a second thermoplastic polymer. The first and the second thermoplastic polymer have different yield behavior, whereby the multi-component filaments are self-crimping.

### TECHNICAL FIELD

The present invention relates to a carpet comprising a backing and pile comprising tufts of pile yarn extending from the backing. Further, the invention relates to a method of producing such a carpet.

### BACKGROUND

For long, carpets and rugs have been used as textile floor coverings to provide comfort, durability, safety, and decoration. The terms carpets and rugs are used interchangeably in the art. They may be used to cover the entire floor in a room and fastened thereto. Sometimes, the term carpet is used to denote such a floor covering. The term carpet may however also be used to denote a textile floor covering not fastened and typically not covering the entire floor, in the same manner as the term rug is used.

Carpets typically comprise a backing to which a pile is attached and the requirements include to provide comfort (e.g. resilience) and decoration (e.g. pattern). In the art, various techniques have been used to provide carpets. Commonly a pile yarn is threaded through the backing and attached thereto. The backing may either be woven in situ (e.g. Axminster and Wilton carpets) or it may be a pre-woven backing or pre-made non-woven backing (e.g. tufted carpets). In FIG. 1, a close up of a carpet with a woven backing with wrap yarn and weft yarn is shown. The pile yarn is threaded through the backing and thereby attached thereto.

Various types of pile yarn including natural fibers (e.g. cotton and wool) as well as synthetic fibers (e.g. various plastic fibers, such as polyesters fibers) have been used in the art. The yarn may be plied yarn, for example comprising two or more yarns twisted together. Plied yarn provides improved durability.

In U.S. Pat. No. 3,380,242, the production of voluminous yarn and more particularly a method in which a yarn, especially a continuous filament yarn, is subjected to the action of a turbulent stream of fluid, the resulting yarn, and fabrics made therefrom, having a characteristic appearance and handle similar to those of a staple fiber yarn, is disclosed. The yarn is stated to inter alia be useful to manufacture of a tufted carpet.

Yarns are used in various applications apart from carpets, with quite different and distinct requirements. In US 2004/093845, an entangled continuous filament yarn useful in making woven and knit fabrics wherever stretch characteristics are desirable, for example in apparel, accessories, upholstery, and the liken is disclosed. The yarn comprises at least two bi-component filaments each comprising PTT (poly(trimethylene terephthalate)) and PET (poly(ethylene terephthalate)).

In order to facilitate recycling of carpets it would be desired to provide for use of the same material in the backing as in the pile. However, today cheaper materials are typically used in the backing to reduce the cost, whereas more expensive materials are used in the visible pile. As an example, synthetic fibers may be used in the backing whereas natural fibers, e.g. wool fibers are used in the pile. It would thus be of interest to provide a yarn of synthetic fibers resembling e.g. a wool yarn.

Further, it would be desired to reduce the surface weight of carpets, still providing essentially the same comfort and appearance. This would reduce the material usage, as well as the costs, in producing carpets.

### SUMMARY

Accordingly, there is according to a first aspect provided a carpet. The carpet comprises a backing and a pile comprising looped or cut tufts of pile yarn attached to and extending from the backing. The pile yarn may be attached to the backing in various manners as known in the art. Thus, the backing may be woven concurrently with attaching the pile yarn as for e.g. Axminster and Wilton carpets. The backing may thus comprise warp yarn and weft yarn crossing each. The pile yarn may be threaded through the woven web and attached thereto. The pile yarn is bent 180 degrees over the warp yarn or weft yarn. Alternatively, the pile yarn may be attached to, e.g. by threading there through, a pre-made backing (e.g. tufted carpets). The pre-made backing may be a woven or a non-woven backing. The pre-made backing is typically a mesh like structure, i.e. a web.

The carpet may further have more than one backing, such as a primary backing to which the pile yarn is attached and a secondary backing forming a rear, i.e. lower, face of the carpet. Further, an adhesive may be arranged at the rear side of the backing, e.g. a first backing, from which the pile yarn extends. The adhesive serves to secure the pile yarn. The adhesive may be interposed between a primary backing, from which the pile yarn extends, and a secondary backing forming a rear face of the carpet.

The pile yarn comprises un-twisted, entangled filaments. Untwisted, but entangled filaments provide a comfortable pile. The un-twisted, entangled filaments are self-crimped, and optionally textured, multi-component filaments. A first component of the multi-component filaments comprises a first thermoplastic polymer and a second component of the multi-component filaments comprising a second thermoplastic polymer. The first and the second thermoplastic polymers have different yield behavior, e.g. different stress relaxation response, different melt flow rate, different elastic rate, and/or different intrinsic viscosity, whereby the multi-component filaments are self-crimping, i.e. they crimp if they are stretched. Self-crimping multi-component filaments are known in the art (cf. e.g. U.S. Pat. No. 6,158,204). Further, at least one of the thermoplastic polymers are spinnable.

It has now been found that pile yarn comprising filaments being self-crimped multi-component filaments increase the bulk of the pile yarn while maintaining or even improving its mechanical properties. Thus, a pile comprising tufts of such a pile yarn with the desired properties, e.g. resilience, may be provided with less pile yarn, i.e. lower surface weight. Further, the coverage is improved given the increased bulk (i.e. the backing remains invisible being hidden by the pile even with a reduced surface weight). Actually, it was found that a material reduction of up to 40% on a weight basis may be achieved.

In order to further increase the bulk, the filaments in the pile yarn may be textured. As recognized in the art, “textured” is a generic term for filament(s) that have been given notably greater apparent volume or bulk than conventional yarns of similar filament count or which have been made more extensible by filament distortion. Texturing is typically provided by physical treatment, chemical treatment, heat treatment, or any combination of these.

Self-crimping is provided by drawing multi-component filaments and requires the components of the filaments itself to have different yield behavior. In contrast to this texturing is not induced by the filament in itself but results from external factors, such as physical treatment, chemical treatment, heat treatment, or any combination of these.

Without being bound to any hypothesis, it is believed that the self-crimping, inducing “helical” segments, provides unique properties to the present pile yarn. Further, optional texturing (“random” creasing) of the present pile yarn may provide additional improvement to the on provided by the self-crimping. These properties, especially the increased bulk, are further improved if the filaments in the yarn are un-twisted, but entangled filaments. It was found that twisting the filaments significantly decreases the bulk provided by the texturing and the self-crimping. Further, a pile yarn comprising filaments being self-crimped and optionally textured multi-component filaments extends the life of the carpet since the crimp does not flatten out with wear.

In order to provide a self-crimping multi-component filament, the components are typically arranged side-by-side in the filament. Less preferably, they are arranged in a sheath-core like manner, this however require them to be arranged eccentrically, as self-crimping not is induced if they are symmetrically arranged around the center of the filament. According to an embodiment, the components are arranged eccentrically, such as side-by-side. The multi-component filaments are typically bi-component filament with at least one of the two components arranged eccentrically. Preferably, both components are arranged eccentrically. The first and second thermoplastic polymers are thus distributed unsymmetrical over the cross-section of the multi-component filament.

While the filaments may comprise more than two components, the filament is typically a bi-component filament. According to an embodiment, the filament is a bi-component filament.

The cross-section of the multi-component filaments may vary. While the cross-section may be round, it is preferred if the cross-section is not round in order to improve the bulkiness of the filaments and thus the bulk of the yarn. According an embodiment, the cross-section of the bi-component filaments has at least two lobes, such as at least three lobes. Preferably the cross-section is bi-lobal (i.e. dog bone like), tri-lobal, or quad-lobal, such as tri-lobal or quad-lobal. In a filament with a bi-lobal cross-section, the waist of the bi-lobal cross-section is preferably concave. Similarly, the sides of the tri-lobal and the quad-lobal cross-sections are preferably concave.

According to an embodiment, the multi-component filament is a bi-component filament whose cross-section is bi-lobal. According to such an embodiment, a first lobe may comprise the first thermoplastic polymer and a second lobe may comprise the second thermoplastic polymer. Further, in order improve the self-crimping the first lobe does preferably not comprise the second thermoplastic polymer. Similarly, the second lobe does preferably not comprise the first thermoplastic polymer.

Compared to a carpet with pile yarn comprising filaments with a round cross-section, a carpet with pile yarn comprising filaments with a bi-lobal cross-section provides not only more bulk, but also a softer hand-feel and touch. Without being bound by any theory, this may be due to the internal crimp/twist implying that the hand touches bent sides. Further, filaments with a bi-lobal cross-section are more like a (flat) strip than as a (circular) cable, thus they tend to bend easier upon hand contact giving a smoother feeling. In addition, a multi-component filament with a bi-lobal cross-section provides a more wool like feeling.

According to an embodiment, the multi-component filament is a bi-component filament whose cross-section is tri-lobal. According to such an embodiment, one to two lobes comprises the first thermoplastic polymer and the remaining one to two lobes comprises the second thermoplastic polymer. Further, in order improve the self-crimping at least one lobe does preferably only comprise the first or the second thermoplastic polymer, i.e. it does not comprise the first or the second thermoplastic polymer. Compared to a carpet with pile yarn comprising filaments with a round cross-section, the filaments with a tri-lobal cross-section provides significantly more bulk to the carpet and thus also a better coverage.

The relative proportions of the two thermoplastic polymers may vary. The first thermoplastic polymer may be present in an amount of 5 to 95 wt %, such as 10 to 90 wt %, in the multi-component, such as bi-component, filament. Correspondingly, the second thermoplastic polymer may be present in an amount of 95 to 5 wt %, such as 90 to 10 wt %. According to an embodiment, one of the thermoplastic polymers is present in a higher amount than the other. Preferably, the less costly thermoplastic polymer is present in amount of 50 to 95 wt %, such as 50 to 90 wt %.

At least one of the thermoplastic polymers in the filaments are spinnable polymers. The at least two thermoplastic polymers may be the same kind of polymers, as long as their yield behavior, e.g. their intrinsic viscosity, differ, or they may be different kinds of polymer (e.g. PET and PBT).

According to an embodiment, the first thermoplastic polymer is selected from the group consisting of polyethyleneterephthalate (PET), modified PET (e.g. PET modified with up to 20 mole percent isophthalic acid or PET modified by incorporating polyolefin (e.g. PE or PP) segments), polybutyleneterephthalate (PBT), poly(trimethylene terephthalate) (PTT), polyethylene furanoate (PEF), co-polyesters, polyamides (such as nylon 6 (PA6), nylon 6/6 (PA6,6), and nylon 6/12 (PA6,12)), modified polyamides (e.g. polyamides modified with cationically dyeable groups or ultraviolet light stabilizers or polyamides modified by incorporating polyolefin (e.g. PE or PP) segments), co-polyamides, polyethylene (PE), polypropylene (PP) (such as isotactic polypropylene and syndiotactic polypropylene), and other spinnable polymers.

Further, the first thermoplastic polymer may be a biodegradable polymer, such as polylactic acid (PLA), polybutylene succinate (PBS), polyethylene furanoate (PEF), or polyhydroxyalkanoate (PHA), e.g. Polyhydroxybutyrate (PHB). According to an embodiment, the first thermoplastic polymer is selected from the group consisting of polyethyleneterephthalate (PET), modified PET (e.g. PET modified with up to 20 mole percent isophthalic acid or PET modified by incorporating polyolefin (e.g. PE or PP) segments), polybutyleneterephthalate (PBT), polyethylene furanoate (PEF), co-polyesters, and biodegradable polymers, such as polylactic acid (PLA), polybutylene succinate (PBS), polyethylene furanoate (PEF), and polyhydroxyalkanoate (PHA), e.g. Polyhydroxybutyrate (PHB). According to an embodiment, the first thermoplastic polymer is selected from the group consisting of polyethyleneterephthalate (PET), modified PET (e.g. PET modified with up to 20 mole percent isophthalic acid or PET modified by incorporating polyolefin (e.g. PE or PP) segments), and polybutyleneterephthalate (PBT).

Similarly, according to an embodiment, the second thermoplastic polymer is selected from the group consisting of polyethyleneterephthalate (PET), modified PET (e.g. PET modified with up to 20 mole percent isophthalic acid, or PET modified by incorporating polyolefin (e.g. PE or PP) segments), polybutyleneterephthalate (PBT), poly(trimethylene terephthalate) (PTT), polyethylene furanoate (PEF), co-polyesters, polyamides (such as nylon 6 (PA6), nylon 6/6 (PA6,6), and nylon 6/12 (PA6,12)), modified polyamides (e.g. polyamides modified with cationically dyeable groups or ultraviolet light stabilizers or polyamides modified by incorporating polyolefin (e.g. PE or PP) segments), co-polyamides, polyethylene (PE), polypropylene (PP) (such as isotactic polypropylene and syndiotactic polypropylene), and other spinnable polymers. Further, the first thermoplastic polymer may be a biodegradable polymer, such as polylactic acid (PLA), polybutylene succinate (PBS), or polyhydroxyalkanoate (PHA), e.g. Polyhydroxybutyrate (PHB). According to an embodiment, the second thermoplastic polymer is selected from the group consisting of polyethyleneterephthalate (PET), modified PET (e.g. PET modified with up to 20 mole percent isophthalic acid or PET modified by incorporating polyolefin (e.g. PE or PP) segments), polybutyleneterephthalate (PBT), polyethylene furanoate (PEF), co-polyesters, and biodegradable polymers, such as polylactic acid (PLA), polybutylene succinate (PBS), polyethylene furanoate (PEF), and polyhydroxyalkanoate (PHA), e.g. Polyhydroxybutyrate (PHB). According to an embodiment, the second thermoplastic polymer is selected from the group consisting of polyethyleneterephthalate (PET), modified PET (e.g. PET modified with up to 20 mole percent isophthalic acid or PET modified by incorporating polyolefin (e.g. PE or PP) segments), and polybutyleneterephthalate (PBT).

According to an embodiment, the first thermoplastic polymer is selected from the group consisting of polyethyleneterephthalate (PET), modified PET (e.g. PET modified with up to 20 mole percent isophthalic acid or PET modified by incorporating polyolefin (e.g. PE or PP) segments), and polybutyleneterephthalate (PBT), and the second thermoplastic polymer is selected from the group consisting of polyethyleneterephthalate (PET), modified PET (e.g. PET modified with up to 20 mole percent isophthalic acid or PET modified by incorporating polyolefin (e.g. PE or PP) segments), and polybutyleneterephthalate (PBT). Thus, the at least two thermoplastic polymers may be the same kind of polymers (e.g. PET), as long as their yield behavior, e.g. their intrinsic viscosity, differ. Alternatively, the at least two thermoplastic polymers may be different kinds of polymer (e.g. PET and PBT).

In order to be self-crimping, the first and the second thermoplastic polymer need to have different yield behavior, e.g. to have at least one of: different stress relaxation response, different melt flow rate, different elastic rate, and different intrinsic viscosity. Thus, according to an embodiment the first and the second thermoplastic polymer have different intrinsic viscosity. The difference in intrinsic viscosity between the first thermoplastic polymer and the second thermoplastic polymer may be at least 0.01 dl/g (deciliters/gram), such as at least 0.03 or at least 0.05 dl/g. Further, the difference in intrinsic viscosity between the first thermoplastic polymer and the second thermoplastic polymer may be 0.40 dl/g or less, such as 0.30 dl/g or less, or 0.20 dl/g or less. While the first and the second thermoplastic polymer need to have different yield behavior in order to be self-crimping, it may be costly to use very distinct polymers. Typically, thermoplastic polymers with high intrinsic viscosity are expensive. Thus, it may be preferred to use e.g. different types of PET or PET and PBT, rather for example PET and PTT. The intrinsic viscosity may be determined in accordance with ISO 1628:2009, wherein part 1 defines the general principles, whereas part 2 to 6 defines principles for specific polymers. According to an embodiment, the first and the second thermoplastic polymer have different Melt Flow Rate (MFR). The Melt Flow Rate (MFR), as determined in accordance with ASTM D1238-13, of the first and the second thermoplastic polymer may differ by at least 1%, such at least 2%, at least 5%, or at least 10%.

The pile yarn comprising multi-component filament is obtainable by spinning, i.e. extruding, at least a first melt comprising the first thermoplastic polymer and a second melt comprising the second thermoplastic polymer into a multi-component filament, e.g. a bi-component filament. Typically, the die comprises a number of openings such that multitude of multi-component filaments are provided, i.e. a bundle of filaments to form the yarn. Subsequent to the extrusion, the filaments may be processed in a number of steps to provide a pile yarn comprising self-crimped and optionally textured filaments. The filaments in the bundle are processed such that they are entangled to form a yarn, but not twisted, i.e. the filaments are un-twisted.

According to an embodiment, the pile yarn comprising multi-component filament is obtainable by a process comprising the steps of:
extruding at least a first melt comprising the first thermoplastic polymer and a second melt comprising the second thermoplastic polymer into a multitude (a bundle) of multi-component filaments, e.g. bi-component filaments;
drawing and solidifying the multi-component filaments to provide a multitude of self-crimped multi-component filaments;
optionally texturing and/or stretching the drawn multi-component filaments; and
collecting the multitude of multi-component filaments entangled as a pile yarn.

The multi-component filaments may be stretched and/or textured by air-jets. As recognized by the skilled person, also other gases like nitrogen and carbon dioxide may be used in the jets in texturizing the multi-component filaments. The air-jets may be oriented perpendicular to the longitudinal extension of the multi-component filaments. Alternatively, the air-jets may be oriented parallel to the longitudinal extension of the multi-component filaments. Apart from stretching and/or texturing the multi-component filaments, the air-jets may also entangle them, whereby providing a yarn.

According to an embodiment, the liner mass density of the yarn is 500 to 5000 dtex, such as 1000 to 4000 dtex. Alternatively, the liner mass density of the yarn may be 500 to 5000 denier, such as 1000 to 4000 denier. Further, the bulk (cf. experimental) of the yarn may be at least 15%, such as at least 20% or at least 30%. A filament with a cross-section having at least two lobes may improve the bulk of the yarn.

According to another aspect, there is provided a pile yarn comprising un-twisted, entangled filaments. The filaments are self-crimped, and optionally textured, multi-component filaments. A first component of the multi-component filaments comprises a first thermoplastic polymer and a second component of the multi-component filaments comprising a second thermoplastic polymer. The first and the second thermoplastic polymer have different intrinsic viscosity whereby, the multi-component filaments is self-crimping. Preferred features of the pile yarn and the multi-component filaments, respectively, therein, have been described herein above.

According to another aspect, there is provided method of producing a carpet comprising a backing and pile comprising looped or cut tufts of pile yarn attached to and extending from the backing, wherein the pile yarn comprises un-twisted, entangled filaments. As already described, the filaments are self-crimped, and optionally textured, multi-component filaments. In short, the method comprises providing provide a yarn comprising self-crimped, and optionally textured, multi-component filaments and subsequently attaching the pile yarn to a backing to provide a carpet with a pile, i.e. tufts of pile yarn extending from a backing. The backing may either be woven in situ or it may be a pre-woven backing or a pre-made non-woven backing. The tufts may be looped tufts or cut tufts.

According to an embodiment, the method comprises the steps of:
extruding a first melt comprising a first thermoplastic polymer and a second melt comprising a second thermoplastic polymer, wherein the first and the second thermoplastic polymer have different intrinsic viscosity, into a multitude of multi-component filaments, a first component of the multi-component filament comprising the first thermoplastic polymer and a second component of the multi-component filament comprising the second thermoplastic polymer;
drawing and solidifying the multi-component filaments to provide a multitude of self-crimped multi-component filaments;
optionally texturing and/or stretching the drawn multi-component filaments;
collecting the multitude of multi-component filaments entangled as a pile yarn;
attaching the pile yarn to the backing to provide the backing with tufts of pile yarn extending from the backing; and
optionally cutting the looped piles, whereby providing cut tufts of the pile yarn extending from the backing.

According to an embodiment, the carpet may be heated once the pile yarn has been attached to the backing and optionally cut. The carpet may thus be passed through a flat oven at e.g. 170 degree. The temperature in heating is adopted to the materials used. Such heating may increase the bulk of the pile, as it may become a bit flat in attaching it to the backing. Thus, the heating may improve the yarn coverage. Further, such heating enhance the pile appearance, as during tufting the pile yarn is under tension and heating helps to relieve the tensions used during production.

Preferred features of the carpet, the pile yarn and the multi-component filaments, respectively, therein, have been described herein above.

According to another aspect, there is provided method of producing a carpet pile yarn, the pile yarn comprising un-twisted, entangled filaments, wherein the method comprising the steps of:
extruding a first melt comprising first thermoplastic polymer and a second melt comprising second thermoplastic polymer, wherein the first and the second thermoplastic polymer have different intrinsic viscosity, into a multitude of multi-component filaments, a first component of the multi-component filaments comprising the first thermoplastic polymer and a second component of the multi-component filaments comprising the second thermoplastic polymer;
drawing and solidifying the multi-component filaments to provide a multitude of self-crimped multi-component filaments;
optionally texturing and/or stretching the drawn multi-component filaments; and
collecting the multitude of multi-component filaments entangled as a pile yarn;

Preferred features of the pile yarn and the multi-component filaments, respectively, therein, have been described herein above.

Although the present invention has been described above with reference to specific embodiments, it is not intended to be limited to the specific form set forth herein. Rather, the invention is limited only by the accompanying claims and other embodiments than the specific embodiments described above are equally possible within the scope of these appended claims.

In the claims, the term “comprises/comprising” does not exclude the presence of other elements or steps. Additionally, although individual features may be included in different claims, these may possibly advantageously be combined, and the inclusion in different claims does not imply that a combination of features is not feasible and/or advantageous.

In addition, singular references do not exclude a plurality. The terms “a”, “an”, “first”, “second” etc. do not preclude a plurality.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which:

FIG. 1 showing a close up of a carpet with wrap yarn, weft yarn and pile yarn;

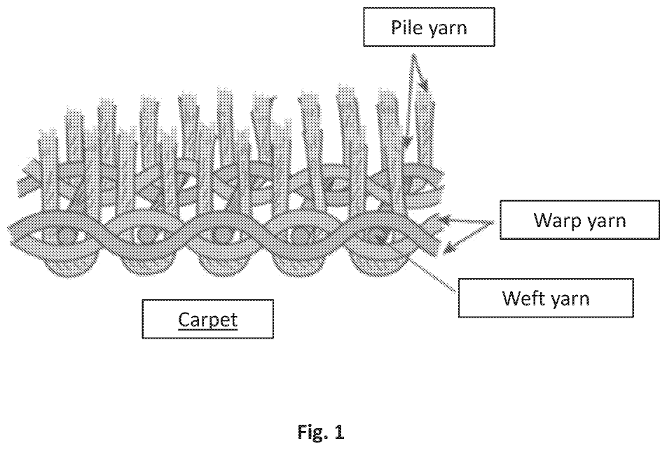

FIG. 2a-b shows cross-sections of filaments with a tri-lobal cross-section according an embodiment;

FIG. 3 shows a cross-section of filaments with a dog bone like cross-section according an embodiment;

FIG. 4 shows photographs of pile yarn comprising a) conventional filaments (control); b) filaments with a dog bone like cross-section; and c) filaments with a tri-lobal cross-section;

FIG. 5 shows photographs of carpets with pile yarn comprising a) conventional filaments (control), b) to d) filaments according an embodiment

### EXPERIMENTAL

Filament Spinning

Various pile yarn comprising un-twisted, entangled filaments were produced by fiber spinning. As known in the art, in polymer spinning the polymers are melted in an extruder and volumetrically pumped into a spinneret that has a die with multiple small precision extrusion holes. In spinning bi-component filaments, two types of polymers are fed to each extrusion hole.

Subsequently, the melt is drawn from the extrusion holes and cooled with air to solidify the resulting filaments. The drawing of the filaments induces self-crimping. The filaments may be drawn upon solidifying, as well once they have solidified.

The drawn filaments are fed in to a texturizing jet where hot air is blown parallel to the filaments, pushing them in to a compacting zone where the filament is piled into a slow moving “plug” that is cooled while the filaments are in a “bent” state so as to retain the bend in the filaments. After cooling, the filaments are pulled off the plug to be wound on a bobbin. Filaments obtained in this manner were used in the examples below.

Alternatively, drawn filament may be pulled through a texturizing jet where room temperature air is blown at high velocity perpendicular to the filament causing random and chaotic movement of the filaments. This caused the filaments to crimp and entangle.

Bulk and Shrinkage Test Methods

The bulk and the shrinkage of the yarn was assessed by the following procedure:
1. Wind two skeins (Skein #1 and Skein #2, respectively) of yarn of sufficient revolutions to result in a loading of 0.0009 grams per denier when stressed with a 50 gram weight (1300 denier yarn: 22 revolutions, 2000 denier yarn: 14 revolutions; and 2600 denier yarn: 11 revolutions). Place a paper clip on each skein and hang the skeins on separate hooks.
2. Hang a 50 gram weight on the first skein (Skein #1—Bulk). Hang a 10 lb. (4540 gram) weight on the second skein (Skein #2—Shrinkage).
3. Read skein length L1 for Skein #1 and L2 for Skein #2.
4. Remove the weights and place the skeins in bulk oven at appropriate temperature (Temps: PP=120° C.; PA6=160° C.; and PET=180° C.) for five minutes.
5. Take skeins out of oven and condition for one minute
6. Hang 50 gram weight from Skein #1 and a 10 lb. (4540 gram) weight from Skein #2.
7. After 30 seconds, read skein length L3 for Skein #1 and L4 for skein #4.
8. Calculate % bulk (Skein #1) and % shrinkage (Skein #2) based on L1 to L4 using the following formulas:

% Bulk (Skein #1)=100*(L1−L3)/L1

% Shrinkage (Skein #2)=100*(L2−L4)/L2

L1=Skein #1 length with 50 gm wt. before heating
L2=Skein #2 length with 10 lb wt before heating
L3=Skein #3 length with 50 gm wt. after heating
L4=Skein #4 length with 10 lb. wt. after heating

Filament

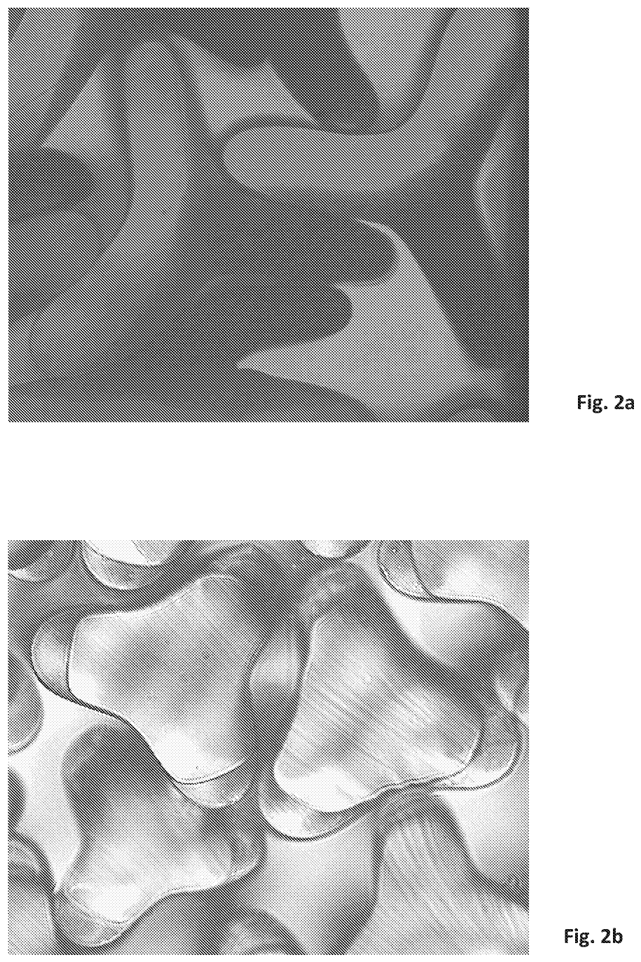

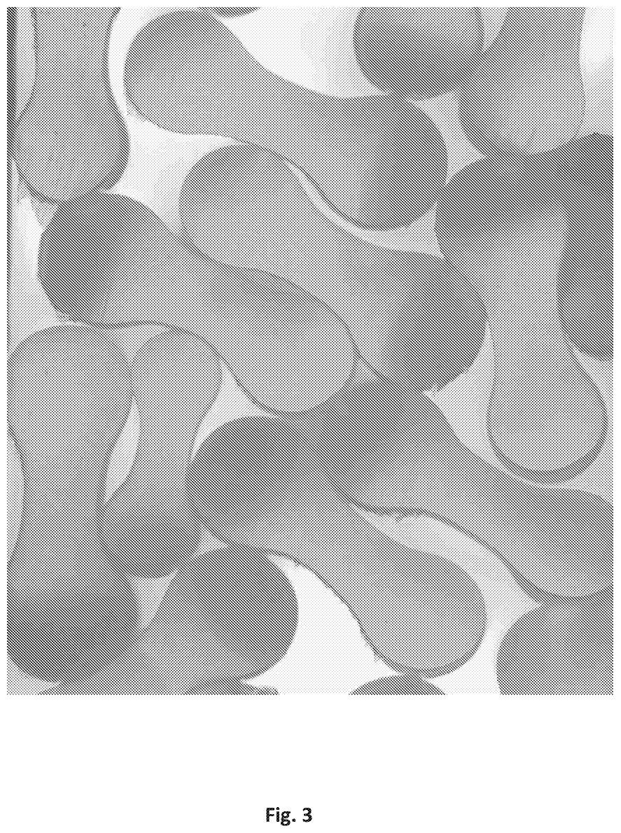

The linear mass density of the yarns used was about the same (i.e. about 2600 to 2900 denier). The cross-section of two types of filaments according the invention are depicted in FIGS. 2 and 3. The first type of filament had a tri-lobal cross-section (cf. FIG. 2). The filaments with a tri-lobal cross-section comprise PET (Eastman F61HC having an intrinsic viscosity of 0.61) and PBT (Ticona 1401 having a MFR of 54). The second type of filament had a dog bone like cross-section (cf. FIG. 3). The filaments with a dog bone like cross-section comprise PET (Eastman F61HC having an intrinsic viscosity of 0.61) and PET (Nanya having an intrinsic viscosity of 0.67).

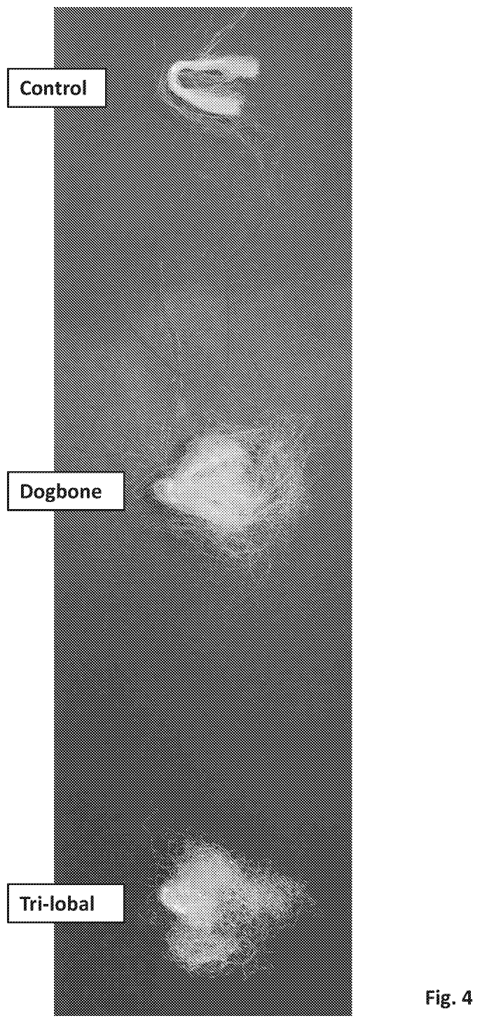

As can be seen from FIG. 4, pile yarn with filaments according to the present invention provides significantly bulkier pile yarn. The textured yarn with mono-component filaments having a round cross-section (control) had a bulk of 12%, whereas the yarn with bi-component filaments with dog bone like cross-section had a bulk of nearly 20% and the yarn with bi-component filaments with tri-lobal cross-section had a bulk of about 40%. A slight variation in the bulk (i.e. 1 to 2 units of percentage) could be seen depending on the proportions (25/75 to 75/25) of the two components.

Carpets

Further, the various pile yarn was used to prove sample carpets. In short, samples were produced by a machine tufting technique using a gauge of 10 needles per inch. The stitch rate (number of tufts in 10 cm) was varied to provide the desired pile weight.

A number of sample carpets were provided, as can be seen from table 1 below.

TABLE 1
sample carpets

| | Pile | Pile | |
|---|---|---|---|
| Pile yarn | height | weight | Assessment |
| Control | 9 mm | 1000 g/m² | — |
| Dog bone | 9 mm | 1000 g/m² | Better touch and softer feeling |
| | | | compared to Control |
| Tri-lobal | 9 mm | 1000 g/m² | Very dense surface |
| Tri-lobal | 9 mm | 750 g/m² | More dense surface than Control |
| Tri-lobal | 9 mm | 600 g/m² | Similar density and feel as Control |

Interestingly, it was found that with the yarn comprising filaments having a dog bone like cross section, a better touch and softer feeling compared to control with the same amount of pile yarn was provided. It is envisaged that the amount of pile yarn can be reduced using the dog bone like cross section, still having a corresponding feeling as for the Control. Further, for some applications the better touch and the softer feeling is a highly desired property. Similar results were obtained with a pile height of 12 mm.

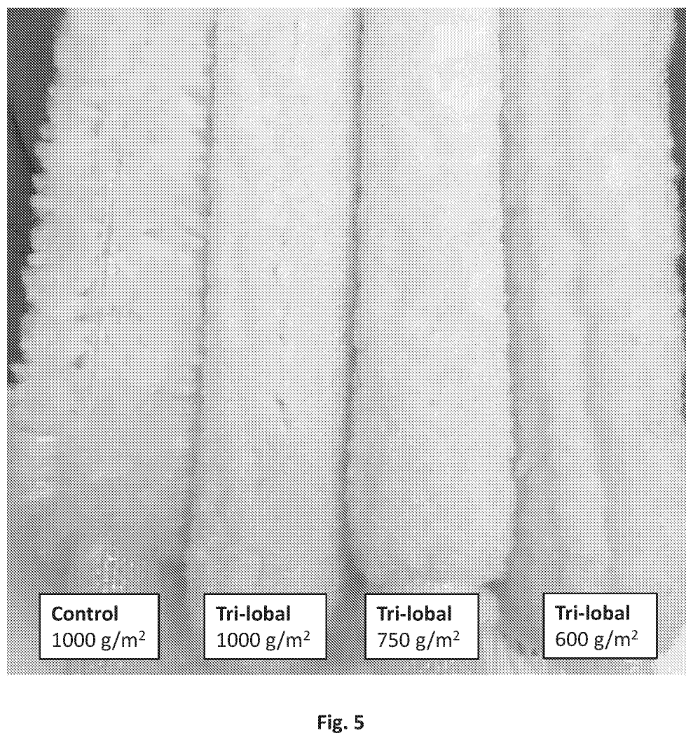

Further, it was found that the increased bulk provided by the tri-lobal filaments (cf. above) implies that much less pile yarn (40%) of this type is required to provide a carpet with essentially the same density and feeling as for the Control. Turning to FIG. 5, it can also be seen that yarn with filaments having a tri-lobal cross section provide very much improved coverage. Corresponding results were obtained with a pile height of 12 mm as well. Further, also with shorter pile (e.g. 6 mm) the amount of pile yarn could be reduced using the tri-lobal filaments.

1. A carpet, the carpet comprising a backing and a pile comprising looped or cut tufts of pile yarn attached to and extending from the backing, wherein the pile yarn comprises un-twisted, entangled filaments, the filaments being self-crimped, and optionally textured, multi-component filaments, a first component of the multi-component filament comprising a first thermoplastic polymer and a second component of the multi-component filament comprising a second thermoplastic polymer, wherein the first and the second thermoplastic polymers have different yield behavior, the multi-component filaments thereby being self-crimping.

2. The carpet according to claim 1, wherein the first and/or the second thermoplastic polymer is distributed eccentrically over the cross-section of the multi-component filament; and/or wherein the multi-component filament is a bi-component filament; and/or wherein the first and the second thermoplastic polymer have at least one of: different stress relaxation response, different melt flow rate, different elastic rate, and different intrinsic viscosity.

3. The carpet according to claim 1, wherein multi-component filaments are bi-component filaments, and/or wherein the first thermoplastic polymer is present in an amount of 5 to 95 wt % in the multi-component filament, and the second thermoplastic polymer is present in an amount of 95 to 5 wt %.

4. The carpet according to claim 1, wherein the pile yarn is obtainable by a process comprising the steps of:
extruding at least a first melt comprising the first thermoplastic polymer and a second melt comprising the second thermoplastic polymer into a multitude of multi-component filaments;
drawing and solidifying the multitude of multi-component filaments to provide a multitude of self-crimped multi-component filaments;
optionally texturing and/or stretching the drawn multitude of multi-component filaments; and
collecting the multitude of multi-component filaments entangled as a pile yarn.

5. (canceled)

6. The carpet according to claim 1, wherein the cross-section of the multi-component filament is bi-lobal, tri-lobal or quad-lobal.

7. The carpet according to claim 6, wherein the cross-section of the multi-component filament is tri-lobal or quad-lobal, and wherein the sides of the tri-lobal and/or the quad-lobal cross-section are concave.

8. The carpet according to claim 1, wherein:
the first thermoplastic polymer is selected from the group consisting of polyethyleneterephthalate (PET), modified PET, polybutyleneterephthalate (PBT), poly(trimethylene terephthalate) (PTT), co-polyesters, polyamides (PA), modified polyamides, co-polyamides, polyethylene (PE), polypropylene (PP), polylactic acid (PLA), polybutylene succinate (PBS), polyethylene furanoate (PEF), and polyhydroxyalkanoate (PHA); and
the second thermoplastic polymer is selected from the group consisting of polyethyleneterephthalate (PET), modified PET, polybutyleneterephthalate (PBT), poly(trimethylene terephthalate) (PTT), co-polyesters, polyamides (PA), modified polyamides, co-polyamides, polyethylene (PE), polypropylene (PP), polylactic acid (PLA), polybutylene succinate (PBS), polyethylene furanoate (PEF), and polyhydroxyalkanoate (PHA).

9. (canceled)

10. The carpet according to claim 8, wherein:
the first thermoplastic polymer is selected from the group consisting of polyethyleneterephthalate (PET), modified PET, polybutyleneterephthalate (PBT); and
the second thermoplastic polymer is selected from the group consisting of polyethyleneterephthalate (PET), modified PET, and polybutyleneterephthalate (PBT).

11. The carpet according to claim 1, wherein the difference in intrinsic viscosity between the first thermoplastic polymer and the second thermoplastic polymer is at least 0.01 dl/g, and wherein the difference in intrinsic viscosity between the first thermoplastic polymer and the second thermoplastic polymer is 0.40 dl/g or less, and/or wherein the liner mass density of the yarn is 500 to 5000 dtex, and/or wherein the bulk of the yarn is at least 15%.

12. The carpet according to claim 1, wherein
the cross-section of the multi-component filament is bi-lobal, wherein a first lobe comprises the first thermoplastic polymer and the second lobe comprises the second thermoplastic polymer; or
the cross-section of the multi-component filament is tri-lobal, wherein one to two lobes comprises the first thermoplastic polymer and the remaining one to two lobes comprises the second thermoplastic polymer.

13. (canceled)

14. (canceled)

15. A method of producing a carpet comprising a backing and a pile comprising looped or cut tufts of pile yarn attached to and extending from the backing, wherein the pile yarn comprises un-twisted, entangled filaments, wherein the filaments are self-crimped, and optionally textured, multi-component filaments, the method comprising the steps of:
extruding a first melt comprising a first thermoplastic polymer and a second melt comprising a second thermoplastic polymer, wherein the first and the second thermoplastic polymer have different yield behavior, into a multitude of multi-component filaments, a first component of the multi-component filament comprising the first thermoplastic polymer and a second component of the multi-component filament comprising the second thermoplastic polymer;
drawing and solidifying the multi-component filaments to provide a multitude self-crimped multi-component filaments;
optionally texturing and/or stretching the drawn multi-component filaments;
collecting the multitude of multi-component filaments entangled as a pile yarn;
attaching the pile yarn to the backing to provide the backing with tufts of pile yarn extending from the backing; and
optionally cutting the looped piles, whereby providing cut tufts of the pile yarn extending from the backing.

16-27. (canceled)

28. A pile yarn comprising un-twisted, entangled filaments, the filaments being self-crimped, and optionally textured, multi-component filaments, a first component of the multi-component filaments comprising a first thermoplastic polymer and a second component of the multi-component filaments comprising a second thermoplastic polymer, wherein the first and the second thermoplastic polymers have different yield behavior, the multi-component filaments thereby being self-crimping.

29. The pile yarn according to claim 28, wherein the first and/or the second thermoplastic polymer is distributed eccentrically over the cross-section of the multi-component filament; and/or wherein the multi-component filament is a bi-component filament; and/or wherein the first and the second thermoplastic polymer have at least one of: different stress relaxation response, different melt flow rate, different elastic rate, and different intrinsic viscosity.

30. The pile yarn according to claim 28, wherein the multi-component filaments are bi-component filaments, and/or wherein the first thermoplastic polymer is present in an amount of 5 to 95 wt % in the multi-component filament, and wherein the second thermoplastic polymer is present in an amount of 95 to 5 wt %.

31. The pile yarn according to claim 28, wherein the pile yarn is obtainable by a process comprising the steps of:
extruding at least a first melt comprising the first thermoplastic polymer and a second melt comprising the second thermoplastic polymer into a multitude of multi-component filaments;
drawing and solidifying the multi-component filaments to provide a multitude of self-crimped multi-component filaments;
optionally texturing and/or stretching the drawn multi-component filaments; and
collecting the multitude of multi-component filaments entangled as a pile yarn.

32. (canceled)

33. The pile yarn according to claim 28, wherein the cross-section of the multi-component filament is bi-lobal, tri-lobal or quad-lobal.

34. The pile yarn according to claim 33, wherein the cross-section of the multi-component filament is tri-lobal or quad-lobal and wherein the sides of the tri-lobal and/or the quad-lobal cross-section are concave.

35. The pile yarn according to claim 28, wherein:
the first thermoplastic polymer is selected from the group consisting of polyethyleneterephthalate (PET), modified PET, polybutyleneterephthalate (PBT), poly(trimethylene terephthalate) (PTT), co-polyesters, polyamides (PA), modified polyamides, co-polyamides, polyethylene (PE), polypropylene (PP), polylactic acid (PLA), polybutylene succinate (PBS), polyethylene furanoate (PEF), and polyhydroxyalkanoate (PHA); and
the second thermoplastic polymer is selected from the group consisting of polyethyleneterephthalate (PET), modified PET, polybutyleneterephthalate (PBT), poly(trimethylene terephthalate) (PTT), co-polyesters, polyamides (PA), modified polyamides, co-polyamides, polyethylene (PE), polypropylene (PP), polylactic acid (PLA), polybutylene succinate (PBS), polyethylene furanoate (PEF), and polyhydroxyalkanoate (PHA).

36. (canceled)

37. The pile yarn according to claim 35, wherein:
the first thermoplastic polymer is selected from the group consisting of polyethyleneterephthalate (PET), modified PET, polybutyleneterephthalate (PBT); and
the second thermoplastic polymer is selected from the group consisting of polyethyleneterephthalate (PET), modified PET, and polybutyleneterephthalate (PBT).

38. The pile yarn according to claim 28, wherein the difference in intrinsic viscosity between the first thermoplastic polymer and the second thermoplastic polymer is at least 0.01 dl/g and wherein the difference in intrinsic viscosity between the first thermoplastic polymer and the second thermoplastic polymer is 0.40 dl/g or less, and/or wherein the liner mass density of the yarn is 500 to 5000 dtex, and/or wherein the bulk of the yarn is at least 15%.

39. The pile yarn according to claim 33, wherein
the cross-section of the multi-component filament is bi-lobal, wherein a first lobe comprises the first thermoplastic polymer and the second lobe comprises the second thermoplastic polymer and/or the second lobe does not comprise the first thermoplastic polymer; or
the cross-section of the multi-component filament is tri-lobal, wherein one to two lobes comprises the first thermoplastic polymer and the remaining one to two lobes comprises the second thermoplastic polymer.

40-54. (canceled)
